(19) United States
(12) Patent Application Publication
(10) Pub. No.: US 2017/0068693 A1
(43) Pub. Date: Mar. 9, 2017

(54) EXPOSING EXTERNAL CONTENT IN AN ENTERPRISE

(71) Applicant: MICROSOFT TECHNOLOGY LICENSING, LLC., Redmond, WA (US)

(72) Inventors: Azmil Macksood, Oslo (NO); Aleksei Nikolaevich Triastcyn, Lausanne (CH); Konstantin Seleskerov, Oslo (NO); Vidar Tveoy Knudsen, Oslo (NO); Panos Sakkos, Oslo (NO)

(73) Assignee: MICROSOFT TECHNOLOGY LICENSING, LLC., Redmond, WA (US)

(21) Appl. No.: 14/845,978

(22) Filed: Sep. 4, 2015

(51) Int. Cl. G06F 17/30

(52) U.S. Cl. CPC G06F 17/30321; G06F 17/30554; G06F 17/30887; G06F 17/30893; G06F 17/30997

(57) ABSTRACT

Exposing content to individuals in an enterprise is provided. An external content sharing system includes a graph server comprising an API engine, a graph index, and an activity processing and analytics engine. When a user selects to share external content via a user agent, the API engine receives an API call including a URL of the external content from the user agent. The API engine accesses the content, extracts metadata, and stores the metadata as a node in the graph index, where connections are made between the node and individuals who are socially close to the user. The API engine receives a query request for content associated with an individual socially close to the user, queries the graph index, and provides a result including the metadata of the external content and the URL for generating and exposing a visual information element representative of the external content to the individual.

### BACKGROUND

In an enterprise situation, for example, a company, school, social network, etc., a given user may encounter hundreds (or more) of documents or other information items, each with varying degrees of relevance, interest, or importance to the user, and that are oftentimes scattered across a variety of workloads and storage systems (e.g., email accounts, calendars, social feeds, intranet sites, network file systems, etc.). In addition to content available to users within enterprise workloads and storage systems, users frequently rely on information that does not reside within enterprise workloads, for example, external content located on the web and available via a network, such as the Internet. Not only may users be unaware of relevant or interesting information items that are available to them, it can be time consuming and inefficient for users to search for enterprise content or external content that is relevant to them.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter. Aspects are directed to an automated system and method for sharing external content with one or more recipients in an enterprise.

An external content sharing system includes a graph server comprising an application programming interface (API) engine, a graph index, and an activity processing and analytics engine. When a user selects to share content that resides external to an enterprise's workloads and storage systems with one or more recipients in the enterprise, an API call including a uniform resource locator (URL) associated with the external content item is made to the API engine. When the API engine is called, it accesses the external content item, extracts various pieces of metadata from the external content item, and sends the extracted metadata to the graph index. The graph index stores the extracted metadata in the form of a node, determines a social distance between the user and other individuals in the enterprise, and creates edges connecting the external content item node to one or more individuals in the enterprise based on their social distance to the user. The API engine is further operable to receive a call to query the graph index for content relevant to a particular individual or specifically for content explicitly shared with the particular individual. Accordingly, the API engine queries the graph index and provides a result of the query including the metadata associated with the external content item to a requesting client application for generating and exposing to the particular individual a selectable visual information element representative of and providing access to the external content item.

Aspects include a method for receiving a URL associated with external content and an indication of a selection to share external content, accessing the external content, extracting metadata associated with the external content, storing the metadata in a graph index, determining one or more recipients of the external content according to social distance, and when a query of the graph index for relevant content for a specific recipient is received, providing the metadata associated with the external content for generation and exposure of a selectable visual information element representative of the external content and for providing access to the external content.

Enabling a user to share external content for propagation and presentation to individuals socially close to the user within an enterprise as information relevant to each individual fosters collaboration within an enterprise and increases individuals' efficiency. For example, providing content relevant to the individual including external content shared by a colleague for exposure to the individual in an intuitive interface helps to increase the individual's knowledge of information that has been determined to be interesting to or relevant to the individual. Accordingly, the individual is enabled to be more efficient and productive by spending less time searching for information.

Examples are implemented as a computer process, a computing system, or as an article of manufacture such as a computer program product or computer readable media. According to an aspect, the computer program product is a computer storage media readable by a computer system and encoding a computer program of instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 is a simplified block diagram showing components of an example system for sharing external content with one or more recipients;

FIG. 2 is a simplified block diagram showing an exchange of messages between components of the external content sharing system;

FIG. 3 is a simplified block diagram showing components of an example external content sharing system for storing external content metadata and propagating the external content to one or more recipients;

FIG. 4 is an illustration of an example user interface for exposing a representation of an external content to a recipient;

FIG. 5 is a flow chart showing general stages involved in an example method for sharing external content with a recipient in an enterprise;

FIG. 6 is a block diagram illustrating example physical components of a computing device;

FIGS. 7A and 7B are simplified block diagrams of a mobile computing device; and

FIG. 8 is a simplified block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present disclosure are directed to exposing content that resides outside of enterprise workloads and storage systems, herein referred to collectively as an enterprise system (e.g., email accounts, calendars, social feeds, intranet sites, network file systems, etc.) to one or more recipients. According to an aspect, metadata is extracted from a selected content item and is stored in a graph index as a node. According to one example aspect, the content item is web-based content. According to another aspect, the selected content item is propagated to one or more recipient users who are connected with a sharing user according to a corporate hierarchy or with whom the sharing user works or communicates on a regular basis. According to another aspect, the sharing user is enabled to explicitly specify one or more recipient users with whom the sharing user wants to share the selected content item.

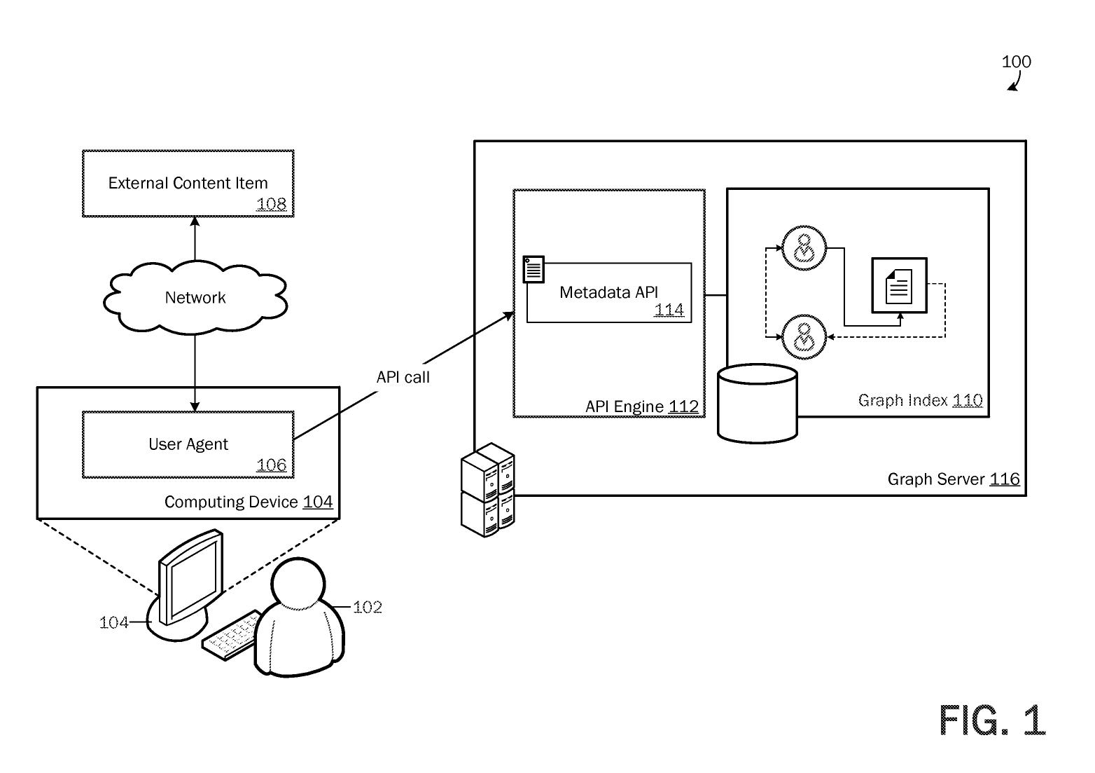

FIG. 1 is a simplified block diagram of one example of an external content sharing system 100. As illustrated in FIG. 1, the external content sharing system 100 includes a graph server 116 comprising an application programming interface (API) engine 112 in communication with a user agent 106 running on a computing device 104. The API engine 112 is communicatively attached to a graph index 110. As will be described in greater detail below, the graph server 116 is operable to intercept, process, and analyze activities associated with individuals and content items from various enterprise workloads within an enterprise system, and store the activities in the graph index 110 for relevant exposure to enterprise users. According to an aspect, the API engine 112 comprises a metadata API 114, and is operable to receive a call from the user agent 106, wherein the call includes a uniform resource locator (URL) associated with an external content item 108 that points to the source of the external content item 108. According to examples, the user agent 106 calls the API engine 112 when an indication of a selection to share an external content item 108 with one or more recipient users is received.

In some examples, the user agent 106 is a browser application operable to access external content items 108 residing on an external server, for example, web-based content that resides outside of an enterprise system (e.g., email accounts, calendars, social feeds, intranet sites, network file systems, etc.). According to an example, an extension is installed on the computing device 104 as a plug-in or add-on to the browser application (i.e., user agent 106) or is embedded in the browser application. In some examples, the extension provides a selectable user interface (UI) component within a toolbar of the browser application or in a contextual UI menu. When a sharing user 102 selects the extension UI component, a message (i.e., API call) including the URL of the external content item 108 is sent to the API engine 112.

In some examples, selection of the extension UI component further provides a UI element (e.g., a pop up box or window) for receiving user input, such as entry of or a selection or deselection of one or more specific recipient users, groups of receiving users, or categories or types of receiving users of the external content item 108. For example, a sharing user 102 may enter a user name, alias, or email address associated with an individual or group of individuals with whom the sharing user 102 want to share the external content item 108. As another example, a list of colleagues or groups or categories of individuals may be displayed in a UI element. A sharing user 102 may select which specific individuals or groups of individuals with which to share the external content item 108.

As another example, when a sharing user 102 selects to share an external content item 108, by default, the external content item 108 may be shared with the sharing user's close colleagues as determined by social distance. The sharing user 102 may not want to share the external content item 108 with all of his/her close colleagues, and thus is enabled to deselect the specific individuals with whom the sharing user 102 does not want to share the external content item 108. As another example, the sharing user 102 may want to share the external content item 108 with additional individuals, and may enter or select a user name, alias, or email address associated with the additional individuals with whom the sharing user 102 wants to share the external content item 108. The selected recipients of the external content item 108 are communicated via the API message.

According to another example, a Hypertext Markup Language (HTML) element, such as a button or link, is added to an external content item 108 (e.g., webpage) by the content item's publisher. When selected, a message (i.e., API call) including the URL of the external content item 108 is sent to the API engine 112. In some examples, selection of the HTML element further provides a UI element (e.g., a pop up box or window) for receiving user input, such as entry of or a selection or deselection of one or more recipient users of the external content item 108 as described above, which is appended to the message.

According to another example, a matrix barcode or other element encodes a URL of an external content item 108. A sharing user is enabled to capture an image of the matrix barcode via a camera associated with the user's computing device 104, and the user agent 106 is operable to read and interpret the encoded URL. The user agent 106 is further operable to send a message (i.e., API call) including the URL of the external content item 108 to the API engine 112. In some examples, scanning a matrix barcode associated with an external content item 108 further provides a UI element (e.g., a pop up box or window) for receiving user input, such as entry of or a selection or deselection of one or more recipient users of the external content item 108 as described above, which is appended to the message.

According to another example, the user agent 106 is a client application, such as a content discovery and surfacing application running on the computing device 104, operable to provide a UI element (e.g., a window, pane, etc.) for receiving user input including a URL of an external content item 108. In some examples, the content discovery and surfacing application is further operable to receive user input, such as entry of or a selection or deselection of one or more recipient users of the external content item 108 as described above. In some examples, the content discovery and surfacing application is further operable to receive user input including metadata associated with the external content item 108, such as a title, summary, keywords, image, tags, etc. Upon receiving an indication of a selection to share the external content item 108, the content discovery and surfacing application is further operable to send a message (i.e., API call) including the URL of the external content item 108 and user input, if any, to the API engine 112.

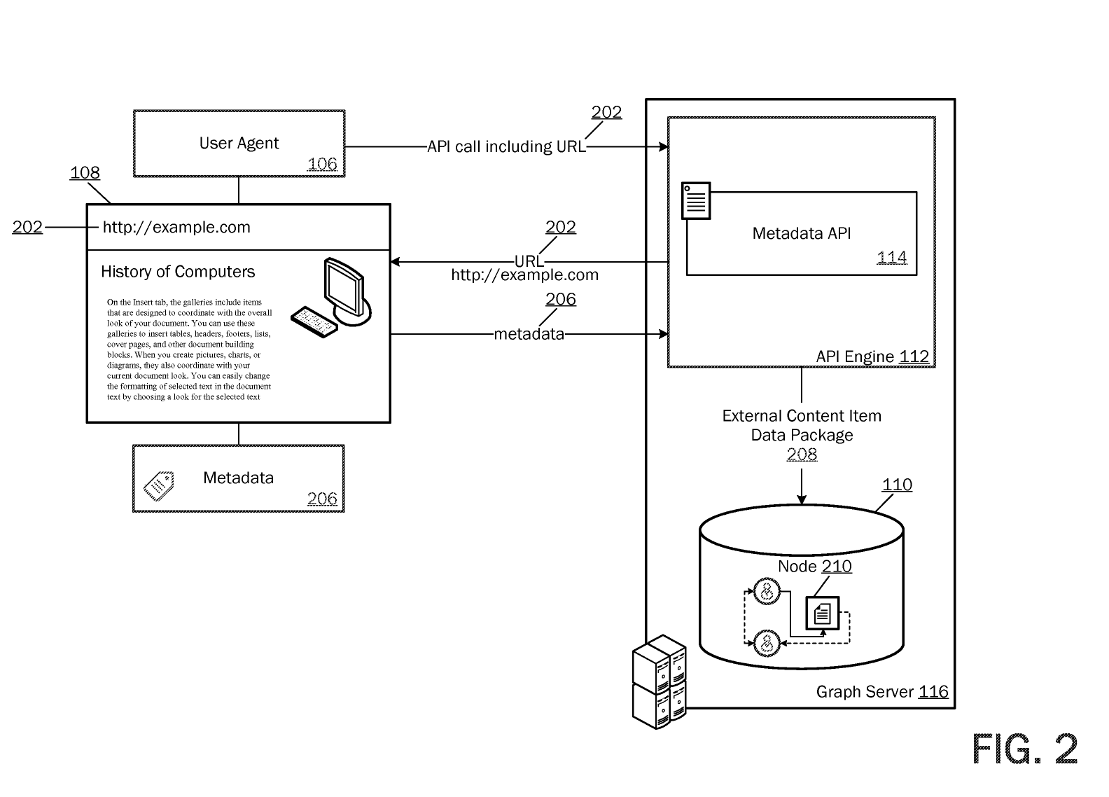

Referring now to FIG. 2, a simplified block diagram showing an exchange of messages between components of the external content sharing system 100. When an API call including a URL 202 associated with an external content item 108 is received by the API engine 112 in response to a selection by a sharing user 102 to share the external content item 108 with one or more recipient users, the API engine 112 exposes the metadata API 114, which uses the URL 202 provided by the user agent 106 to access the external content item 108 and extract various pieces of metadata 206. According to an example, the metadata API 114 searches for and extracts a title element and various page data tags included in the code of the external content item 108. For example, the metadata API 114 extracts one or more of: a title, a summary, a description, an image or screenshot, keywords meta tags, and other meta tags from the external content item 108. In some examples, the sharing user 102 may manually input one or more pieces of metadata 206 associated with an external content item 108. The metadata API 114 further generates an external content item data package 208 comprising the extracted or received metadata 206 and user input, if any, and sends the external content item data package 208 to the graph index 110, where the external content item 108 is stored as a node 210 in the graph index 110. According to an aspect, the node is specified as an external content node that can be discovered in a query of the graph index 110.

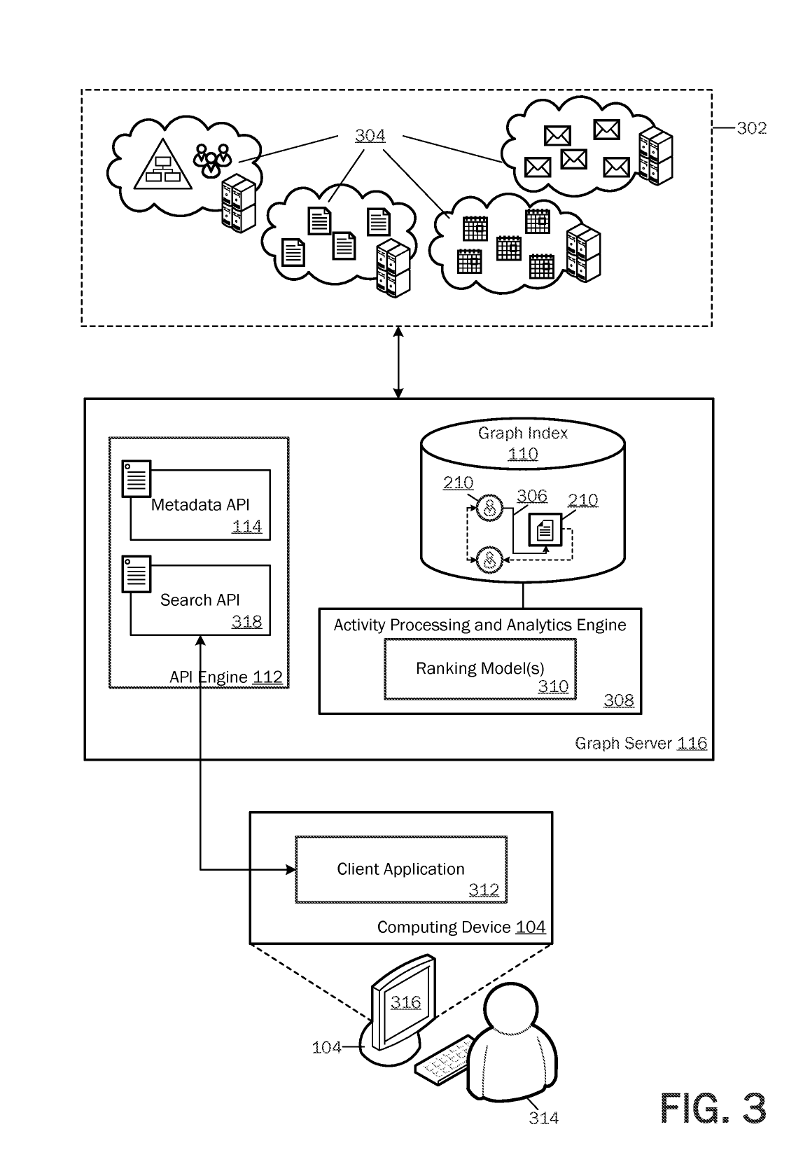

With reference now to FIG. 3, a simplified block diagram comprising components of the external content sharing system 100 for storing the external content item 108 and propagating the external content item 108 to one or more recipient users 314 via the graph server 116 and a client application 312 is illustrated. As illustrated in FIG. 3, an activity processing and analytics engine 308 analyzes and collects a variety of signals of activities from across various enterprise workloads in an enterprise system 302. The workloads in the enterprise system 302 include various enterprise data repositories, which may include remote servers, local or remote databases, local or remote shared resources repositories, social networking service servers, emailing system servers, calendaring system servers, and the like. The enterprise system 302 stores various types of information items 304, such as documents, images, data files, video files, audio files, meeting items, communication items, such as electronic mail items, text messages, telephone messages, posts, blogs, and the like. As users work on information items 304 and interact with their peers and colleagues, activity signals are generated, are collected by the activity processing and analytics engine 308, and are stored in the graph index 110 as a network of nodes 210 and edges 306.

According to examples, the various activity signals that are stored in the graph index 110 enable individuals to be connected to various other individuals in an enterprise (via person-person activity signals) and to various information items 304 (via person-document activity signals). In the graph index 110, people and information items 304 are stored as nodes 210 and are connected to other nodes by edges 306 representative of the activities between people and activities on information items 304 by people in the organization. A user's relationship with another person or with an information item 304 is defined by the activity signals (i.e., edges 306) connecting the user to the person or to the information item 304.

According to aspects, edges 306 include edge properties such as an actor identifier, an object identifier, an action type, a timestamp of the activity, and a weight assigned by one or more ranking models 310. The one or more ranking models 310 are operable to calculate and assign weights to edges 306 based on various factors, such as the type of activity (e.g., sending/receiving an email to/from a person, sending/receiving an instant message to/from a person, attending a meeting with a person, producing an information item, viewing an information item, sharing an information item, liking an information item, commenting on an information item, modifying an information item, etc.), a frequency of activity, an age decay factor, a type of organizational relationship between people (e.g., colleague, peer, manages, directs, etc.), etc.

According to an aspect, when a sharing user 102 acts on an external content item 108 by selecting to share the external content item 108 via a user agent 106 as described above, an activity signal is generated, the external content item 108 is stored as a node 210 in the graph index 110, and the action of sharing the external content item 108 is stored as a “ShareExternalContent” edge 306 connecting the actor (i.e., sharing user 102) to the object (i.e., external content item 108). The URL 202 and the various pieces of metadata extracted by the metadata API 114 (e.g., title, summary, preview image, tags, keywords, etc.) are stored as properties associated with the external content item node 210.

In some examples, when a sharing user 102 selects to share an external content item 108 without entering, selecting, or deselecting a specific receiving user 314, group of receiving users 314, or category or type of receiving users 314, an edge 306 is generated between the shared external content item 108 and one or more colleagues who are determined to be close to the sharing user 102 according to social distance. For example, colleagues who are determined to have a close social distance to the sharing user 102 may include individuals whom the sharing user 102 regularly communicates with, attends meetings with, works together with, interacts with, or with whom the sharing user shares an organizational relationship (e.g., colleague, peer, manages, directs, etc.). According to an aspect, a measure of social distance is calculated by the one or more ranking models 310.

In some examples, when a sharing user 102 explicitly specifies a receiving user 314, for example, by entering or selecting a specific receiving user 314, group of receiving users 314, or category or type of receiving users 314, the activity processing and analytics engine 308 generates an edge 306 (e.g., ShareExternalContent edge) between the node 210 associated with the external content item 108 and the node 210 of the specified receiving user 314.

According to an aspect, the graph server 116 comprises a search API 318, which can be called by a client application 312 to query the graph index 110. For example, the client application 312 is operable to query the graph server 116 via a search API 318 call for external content items 108 associated with a recipient user 314. According to aspects, the client application 312 may include various types of applications operable to submit a query, and receive results from the graph server 116 including one or more external content items 108 shared with the recipient user 314. External content items 108 shared with the recipient user 314 are exposed to the recipient user 314 via the client application 312 executing on a computing device 104, such as a desktop computer, laptop computer, tablet computer, handheld computing device, mobile communication device, wearable device, gaming device, and the like. The computing device 104 is configured to surface the external content item 108 on a display surface 316 associated with the computing device 104.

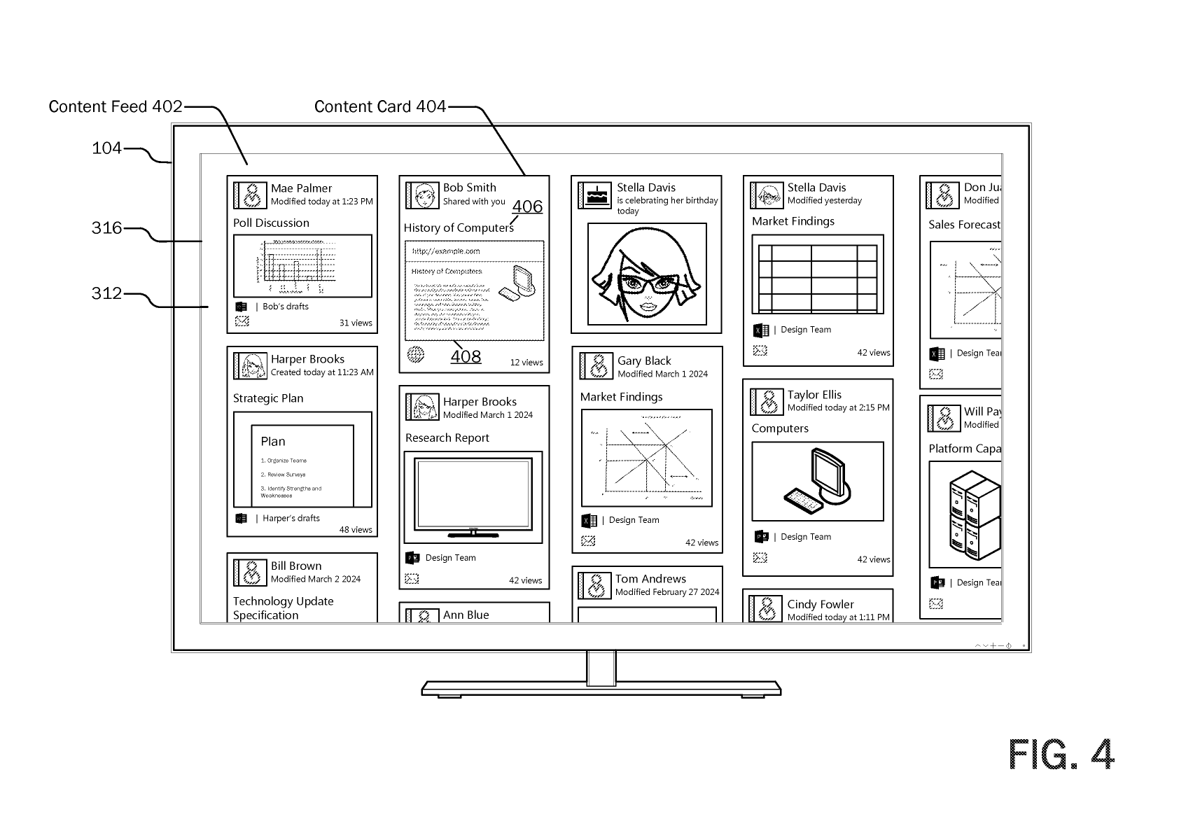

In some examples and as illustrated in FIG. 4, the client application 312 is a content discovery and surfacing application operable to call the search API 318 to query the graph index 110, receive search results including one or more external content items 108 shared with the recipient user 314, generate a visual information element representative of the external content item 108, and expose the visual information element to the recipient user 314 in a user interface. According to an example, the visual information element is a content card 404 that includes one or more pieces of metadata 206 extracted from the external data item 108 by the metadata API 114, such as a title 406, summary, preview image 408, tags, etc. In some examples, additional information is displayed, such as who shared the external data item 108, when the sharing user 102 shared the external data item 108, a link to access the external data item 108, etc. According to an example and as illustrated, the external content item 108 is displayed in a content feed 402 with other content that is determined to be relevant to the recipient user 314 based on a relevance score calculated based on the edge weight. According to another example, the external content item 108 is displayed in a board, such as a “Shared with Me” board that includes content that has been explicitly shared with the recipient user 314.

Having described an operating environment and various aspects with respect to FIGS. 1-4, FIG. 5 illustrates a flow chart showing general stages involved in an example method for sharing external content to one or more recipients in an organization. The method 500 begins at start OPERATION 505 and proceeds to ASYNCHRONOUS OPERATION 510, where activity data associated with information items 304 stored across various enterprise workloads in an enterprise system 302 is collected, analyzed, and stored in the graph index 110 as a network of nodes 210 and edges 306 including various properties about the activity (e.g., type, date, weight assigned by the one or more ranking models 310, etc.).

The method 500 proceeds to OPERATION 515, where a sharing user 102 selects an external content item 108 to share with one or more individuals in the enterprise. The external content item 108 may include such content as a webpage, a blog article, a social information network message, a video sharing website video, an image, an online meeting, an organization-specific entity, or other type of content addressable by a URL 202. As described above, the sharing user 102 utilizes a user agent 106 running on a computing device 104 to enter or select the external content item 108. For example, the sharing user 102 may utilize a browser extension component to selectively share an external content item 108, may select a content sharing button embedded in the external content item 108, may scan a matrix barcode or other element with a camera on a computing device 104, or may enter or copy and paste the URL 202 of the external content item 108 in a specified UI element (e.g., a window, pane, etc.) of an application, such as a content discovery and surfacing application, running on the computing device 104. In some examples, the sharing user 102 is enabled to specify with who he/she wants to share the external content item 108.

The method 500 proceeds to OPERATION 520, where an API call is made to the API engine 112, wherein the call includes the URL 202 associated with the external content item 108 that points to the source of the external content item 108.

The method 500 continues to OPERATION 525, where the API engine 112 responds to the call, and the metadata API 114 uses the URL 202 to visit the external content item 108 and extract various pieces of metadata associated with the external content item 108. According to an example, the metadata API 114 extracts a title element and one or more meta tags, such as one or more of: a summary tag, description tag, keywords meta tag, image meta tag, and other tags.

At OPERATION 530, a package comprising the extracted metadata is created and sent to the graph index 110, and stored in the graph index 110 in the form of a node 210. Activity data associated with the external content item 108 is stored in the form of edges 306. For example, the action of sharing the external content item 108 is stored as an edge 306 connecting the sharing user 102 to the external content item 108. As another example, the action of having the external content item 108 shared with a specified individual is stored as an edge 306 connecting the external content item 108 to the specified individual (i.e., recipient user 314).

As described above, the sharing user 102 may be connected to other individuals in the graph index 110 according to a social distance determined according to who the sharing user 102 regularly communicates with, attends meetings with, works together with, interacts with, or with whom the sharing user shares an organizational relationship (e.g., colleague, peer, manages, directs, etc.). According to an aspect, a measure of social distance is calculated by the one or more ranking models 310. During OPERATION 530, one or more edges 306 are generated between the external content item 108 and one or more recipient users 314 based on social distance. For example, edges 306 are generated and connect the external content item 108 to one or more individuals determined to be the sharing user's 102 colleagues.

The method 500 continues to OPERATION 535, where a query is made for relevant content associated with a recipient user 314. According to an example, a query is made in response to receiving an indication of a selection by a recipient user 314 to view content relevant to the recipient user 314, such as when the recipient user 314 opens a client application 312 (e.g., a content discovery and surfacing application) operable to call the search API 318 to query the graph index 110 for content that is determined to be relevant to the recipient user 314 based on a relevance score calculated based on the edge weight calculated by the one or more ranking models 310.

According to another example, a query is made in response to receiving an indication of a selection by a recipient user 314 to view external content items 108 that have been shared with him/her. Below is an example query for external content items 108 shared with a particular recipient user 314:

### Graph.FindsAllNodes(NodeType=“External”,“RankProfile=“TimeDecay+SocialDistance”

According to another example, a query is made in response to receiving an indication of a selection by a recipient user 314 to view all items that have been shared with him/her by other individuals. According to an aspect, the query is made by a client application 312 running on a computing device 104, wherein the client application 312 makes a call to the search API 318 to query the graph index 110 for content that has been explicitly shared with the recipient user 314 (e.g., “Shared With” edges, “ShareExternalContent” edges, etc.).

The method 500 proceeds to OPERATION 540, where the query of the graph index 110 is made, one or more content items that match the query are fetched, and a response to the query including the one or more fetched items is sent to the client application 312.

At OPERATION 545, a visual information element (e.g., a content card 404) is generated for each content item in the query response. According to an example, for an external content item 108 shared with the recipient user 314, a visual representation of the external content item 108 is generated from the external content item metadata, and includes one or more of: a title 406, a summary, a preview image 408, and tags.

The method 500 proceeds to OPERATION 550, where the one or more visual information elements representative of one or more content items in the query response are exposed to the recipient user 314. According to an example, the one or more visual information elements are exposed to the recipient user 314 in a content feed 402 or a board displayed on a display 316 associated with the computing device 104 as illustrated in FIG. 4.

According to an aspect, the visual information item may comprise one or more selectable features that enable the recipient user 314 to act on the content item represented by the visual information item (e.g., view, share, comment on, like, modify, follow, etc.). In some examples, upon receiving an indication of a selection of the visual information item or a selectable feature of the visual information item (e.g., preview image, title, etc.), the content item represented by the visual information item will be opened. For example, if the visual information item represents an external content item 108 and the recipient user 314 selects the visual information item, a browser application will open and navigate to the external content item 108 addressed by the URL 202 associated with the external content item 108. The method 500 ends at OPERATION 595.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

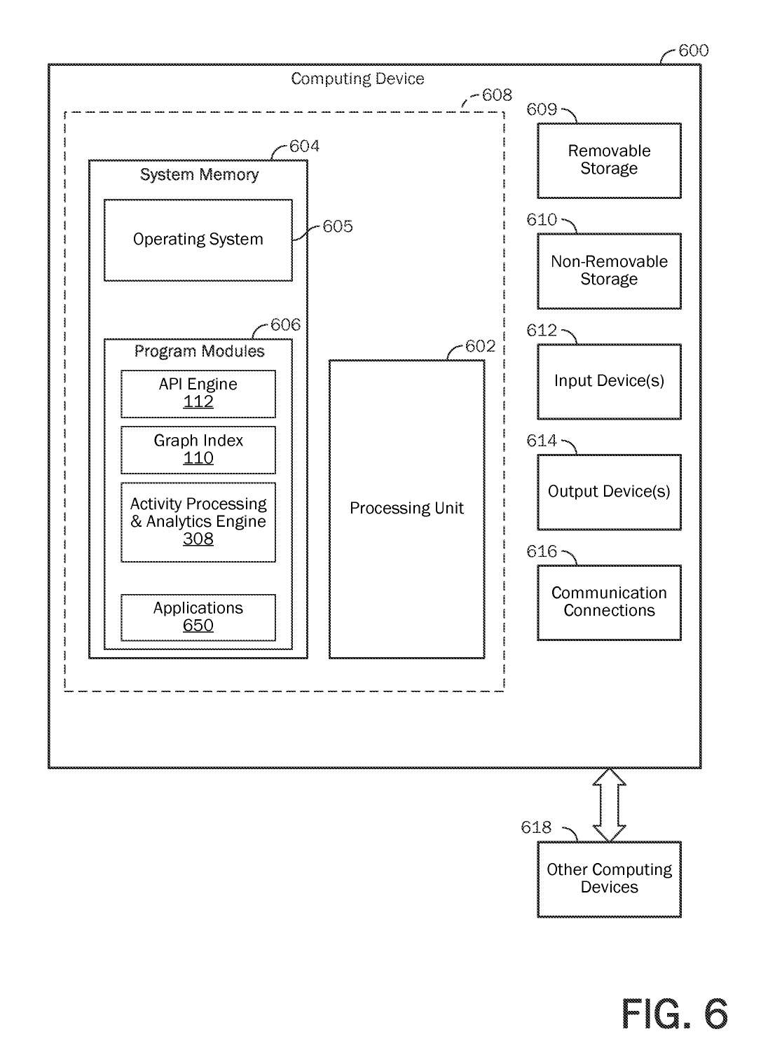

FIG. 6-8 and the associated descriptions provide a discussion of a variety of operating environments in which examples are practiced. However, the devices and systems illustrated and discussed with respect to FIGS. 6-8 are for purposes of example and illustration and are not limiting of a vast number of computing device configurations that are utilized for practicing aspects, described herein.

FIG. 6 is a block diagram illustrating physical components (i.e., hardware) of a computing device 600 with which examples of the present disclosure are be practiced. In a basic configuration, the computing device 600 includes at least one processing unit 602 and a system memory 604. According to an aspect, depending on the configuration and type of computing device, the system memory 604 comprises, but is not limited to, volatile storage (e.g., random access memory), non-volatile storage (e.g., read-only memory), flash memory, or any combination of such memories. According to an aspect, the system memory 604 includes an operating system 605 and one or more program modules 606 suitable for running software applications 650. According to an aspect, the system memory 604 includes the API engine 112, the graph index 110, and the activity processing and analytics engine 308. The operating system 605, for example, is suitable for controlling the operation of the computing device 600. Furthermore, aspects are practiced in conjunction with a graphics library, other operating systems, or any other application program, and is not limited to any particular application or system. This basic configuration is illustrated in FIG. 6 by those components within a dashed line 608. According to an aspect, the computing device 600 has additional features or functionality. For example, according to an aspect, the computing device 600 includes additional data storage devices (removable and/or non-removable) such as, for example, magnetic disks, optical disks, or tape. Such additional storage is illustrated in FIG. 6 by a removable storage device 609 and a non-removable storage device 610.

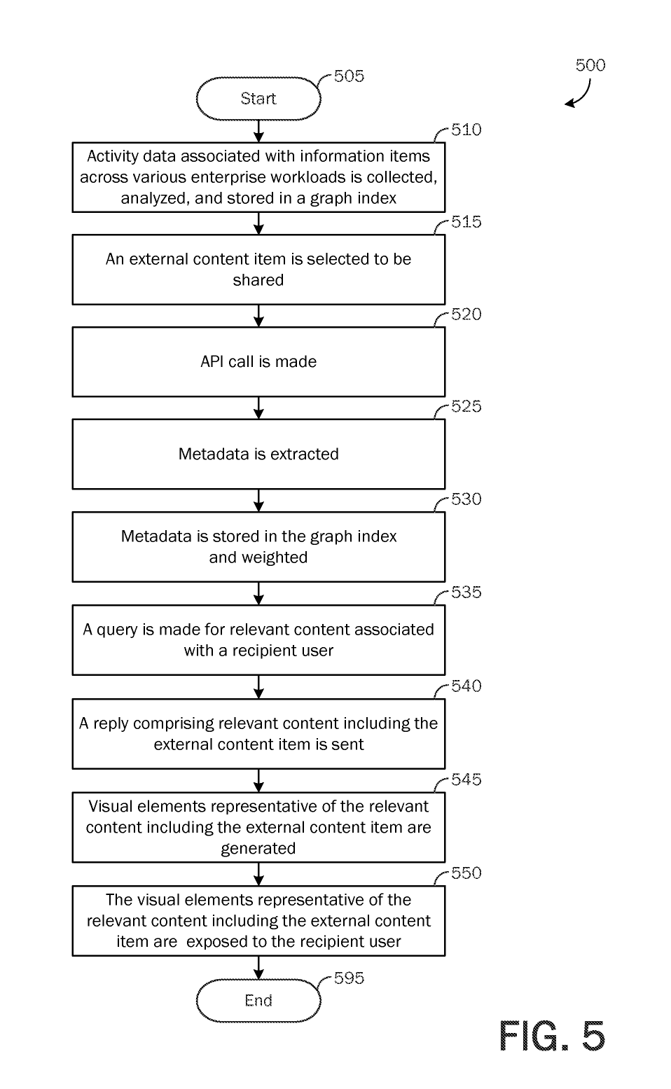

As stated above, according to an aspect, a number of program modules and data files are stored in the system memory 604. While executing on the processing unit 602, the program modules 606 (e.g., API engine 112, the graph index 110, and the activity processing and analytics engine 308) perform processes including, but not limited to, one or more of the stages of the method 500 illustrated in FIG. 5. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 6 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 600 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 600 has one or more input device(s) 612 such as a keyboard, a mouse, a pen, a sound input device, a touch input device, etc. The output device(s) 614 such as a display, speakers, a printer, etc. are also included according to an aspect. The aforementioned devices are examples and others may be used. According to an aspect, the computing device 600 includes one or more communication connections 616 allowing communications with other computing devices 618. Examples of suitable communication connections 616 include, but are not limited to, radio frequency (RF) transmitter, receiver, and/or transceiver circuitry; universal serial bus (USB), parallel, and/or serial ports.

The term computer readable media as used herein include computer storage media. Computer storage media include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) According to an aspect, computer storage media includes RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. According to an aspect, any such computer storage media is part of the computing device 600. Computer storage media does not include a carrier wave or other propagated data signal.

According to an aspect, communication media is embodied by computer readable instructions, data structures, program modules, or other data in a modulated data signal, such as a carrier wave or other transport mechanism, and includes any information delivery media. According to an aspect, the term “modulated data signal” describes a signal that has one or more characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

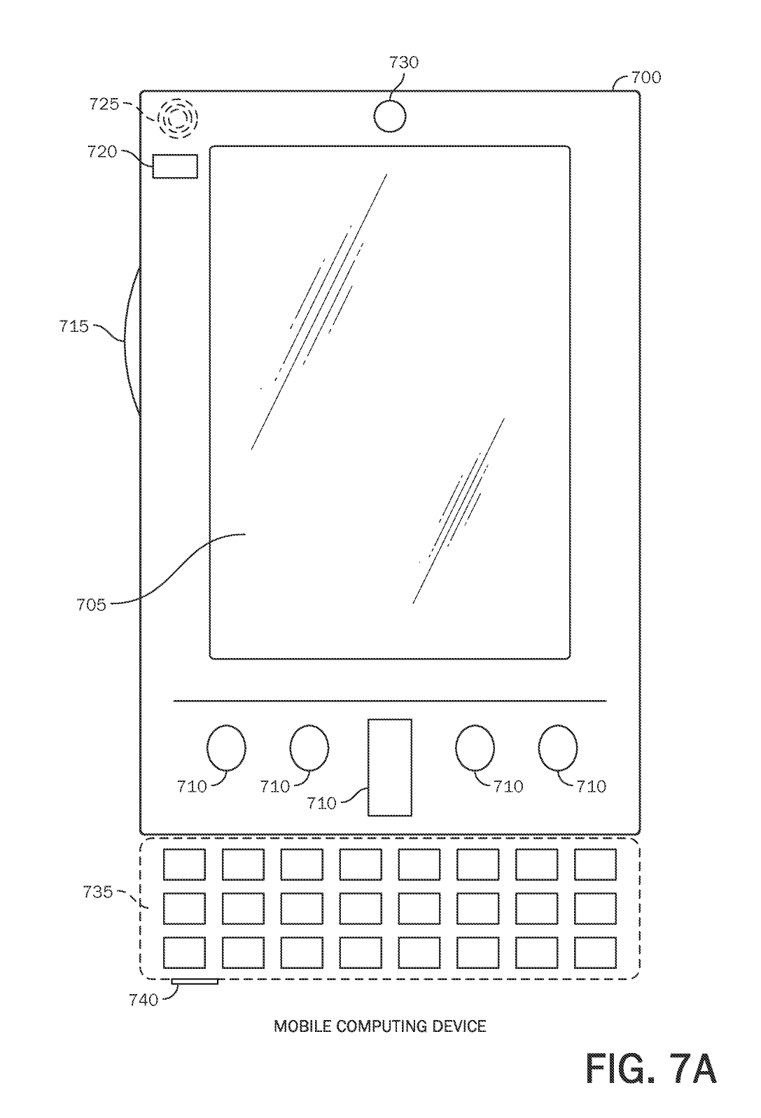

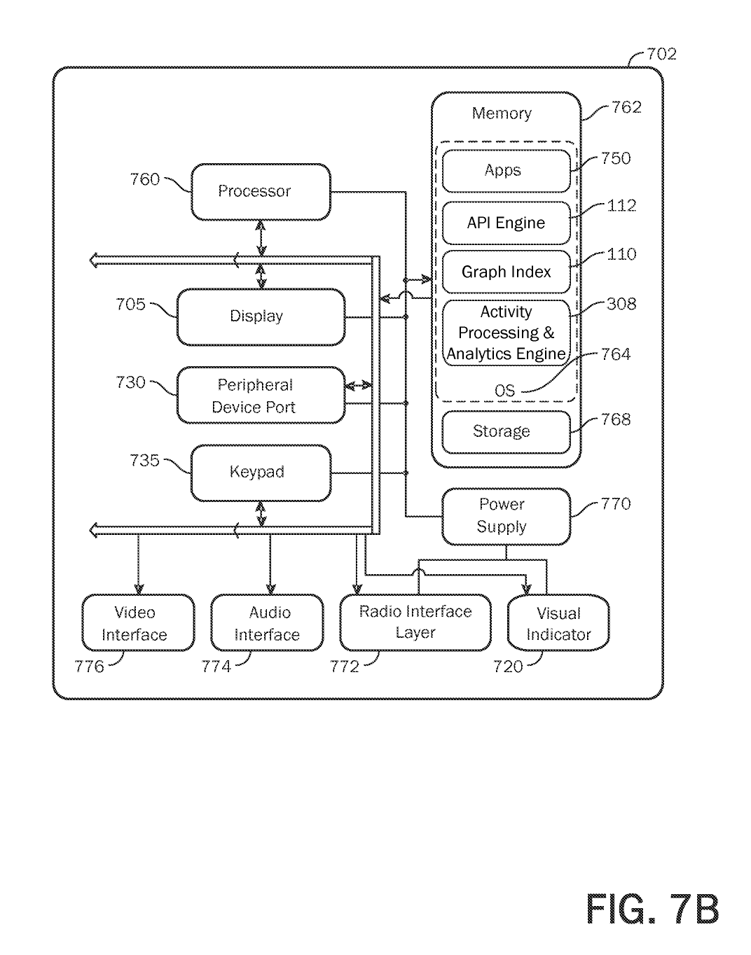

FIGS. 7A and 7B illustrate a mobile computing device 700, for example, a mobile telephone, a smart phone, a tablet personal computer, a laptop computer, and the like, with which aspects may be practiced. With reference to FIG. 7A, an example of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. According to an aspect, the display 705 of the mobile computing device 700 functions as an input device (e.g., a touch screen display). If included, an optional side input element 715 allows further user input. According to an aspect, the side input element 715 is a rotary switch, a button, or any other type of manual input element. In alternative examples, mobile computing device 700 incorporates more or less input elements. For example, the display 705 may not be a touch screen in some examples. In alternative examples, the mobile computing device 700 is a portable phone system, such as a cellular phone. According to an aspect, the mobile computing device 700 includes an optional keypad 735. According to an aspect, the optional keypad 735 is a physical keypad. According to another aspect, the optional keypad 735 is a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some examples, the mobile computing device 700 incorporates a vibration transducer for providing the user with tactile feedback. In yet another example, the mobile computing device 700 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 700 incorporates peripheral device port 740, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one example of a mobile computing device. That is, the mobile computing device 700 incorporates a system (i.e., an architecture) 702 to implement some examples. In one example, the system 702 is implemented as a “smart phone” capable of running one or more applications (e.g., browser, e-mail, calendaring, contact managers, messaging clients, games, and media clients/players). In some examples, the system 702 is integrated as a computing device, such as an integrated personal digital assistant (PDA) and wireless phone.

According to an aspect, one or more application programs 750 are loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. According to an aspect, API engine 112 is loaded into memory 762. The system 702 also includes a non-volatile storage area 768 within the memory 762. The non-volatile storage area 768 is used to store persistent information that should not be lost if the system 702 is powered down. The application programs 750 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700.

According to an aspect, the system 702 has a power supply 770, which is implemented as one or more batteries. According to an aspect, the power supply 770 further includes an external power source, such as an AC adapter or a powered docking cradle that supplements or recharges the batteries.

According to an aspect, the system 702 includes a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 750 via the operating system 764, and vice versa.

According to an aspect, the visual indicator 720 is used to provide visual notifications and/or an audio interface 774 is used for producing audible notifications via the audio transducer 725. In the illustrated example, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. According to an aspect, the system 702 further includes a video interface 776 that enables an operation of an on-board camera 730 to record still images, video stream, and the like.

According to an aspect, a mobile computing device 700 implementing the system 702 has additional features or functionality. For example, the mobile computing device 700 includes additional data storage devices (removable and/or non-removable) such as, magnetic disks, optical disks, or tape. Such additional storage is illustrated in FIG. 7B by the non-volatile storage area 768.

According to an aspect, data/information generated or captured by the mobile computing device 700 and stored via the system 702 is stored locally on the mobile computing device 700, as described above. According to another aspect, the data is stored on any number of storage media that is accessible by the device via the radio 772 or via a wired connection between the mobile computing device 700 and a separate computing device associated with the mobile computing device 700, for example, a server computer in a distributed computing network, such as the Internet. As should be appreciated such data/information is accessible via the mobile computing device 700 via the radio 772 or via a distributed computing network. Similarly, according to an aspect, such data/information is readily transferred between computing devices for storage and use according to well-known data/information transfer and storage means, including electronic mail and collaborative data/information sharing systems.

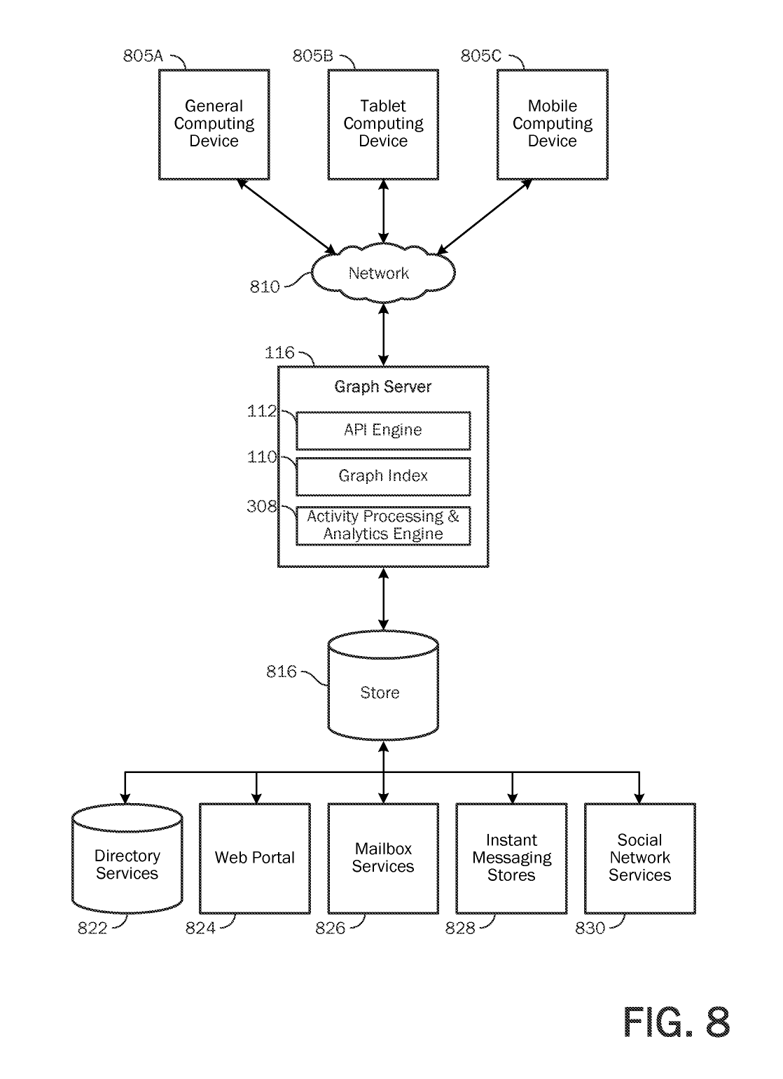

FIG. 8 illustrates one example of the architecture of a system for sharing external content to one or more recipients in an organization as described above. Content developed, interacted with, or edited in association with the API engine 112, the graph index 110, and the activity processing and analytics engine 308 is enabled to be stored in different communication channels or other storage types. For example, various documents may be stored using a directory service 822, a web portal 824, a mailbox service 826, an instant messaging store 828, or a social networking site 830. The API engine 112, the graph index 110, and the activity processing and analytics engine 308 are operable to use any of these types of systems or the like for sharing external content to one or more recipients in an organization, as described herein. According to an aspect, a graph server 116 provides the API engine 112, the graph index 110, and the activity processing and analytics engine 308 to clients 805A,B,C. As one example, the graph server 116 is a web server providing the API engine 112, the graph index 110, and the activity processing and analytics engine 308 over the web. The graph server 116 provides the API engine 112, the graph index 110, and the activity processing and analytics engine 308 over the web to clients 805 through a network 810. By way of example, the client computing device is implemented and embodied in a personal computer 805A, a tablet computing device 805B or a mobile computing device 805C (e.g., a smart phone), or other computing device. Any of these examples of the client computing device are operable to obtain content from the store 816.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A computer-implemented method for exposing content to one or more recipients in an enterprise system, comprising:
receiving a uniform resource locator (URL) associated with an external content item;
discovering information relating to the external content item;
indexing the external content item to propagate to one or more individuals in the enterprise system; and
sharing the external content item via the enterprise system.

2. The computer-implemented method of claim 1, wherein the external content item is a content item that is addressable by a URL and resides external to the enterprise system.

3. The computer-implemented method of claim 1, wherein receiving a URL associated with an external content item comprises receiving an API call including the URL in response to a user selecting to share the external content item via one of:
a content discovery and surfacing application;
a browser application extension;
a Hypertext Markup Language (HTML) element incorporated in the external content item; and
capturing the URL of the external content item encoded as a matrix barcode with a camera.

4. The computer-implemented method of claim 1, wherein discovering information relating to the external content item comprises:
accessing the external content item via the URL; and
extracting one or more pieces of metadata associated with the external content item.

5. The computer-implemented method of claim 4, wherein indexing the external content item to propagate to one or more individuals in the enterprise system comprises:
storing the extracting one or more pieces of metadata associated with the external content item in a graph index; and
determining one or more individuals in the enterprise system as recipients of the external content item.

6. The computer-implemented method of claim 5, wherein determining one or more individuals in the enterprise system as recipients of the external content item comprises:
determining a social distance between a user selecting to share the external content item and one or more individuals in the enterprise system; and
generating an association between the external content item and one or more individuals in the enterprise system based on the social distance between the user and the individual.

7. The computer-implemented method of claim 6, wherein determining a social distance between the user and one or more individuals in the enterprise system comprises identifying one or more individuals who share a colleague relationship with the user.

8. The computer-implemented method of claim 5, wherein determining one or more individuals in the enterprise system as recipients of the external content item comprises:
receiving a selection of one or more individuals in the enterprise system with whom to share the external content item; and
generating an association between the external content item and the one or more individuals selected as individuals with whom to share the external content item.

9. The computer-implemented method of claim 1, wherein sharing the external content item via the enterprise system comprises:
receiving an indication of a query for content associated with an individual who shares a colleague relationship with a user selecting to share the external content item or an individual selected as an individual with whom to share the external content item;
performing the query; and
providing a result including the information relating to the external content item for generating a visual information item representing the external content item.

10. The computer-implemented method of claim 9, wherein receiving an indication of a query comprises receiving an API call to query a graph index for one or more of:
content that is relevant to the individual; and
content that has been shared with the individual.

11. The computer-implemented method of claim 10, wherein performing the query comprises querying the graph index for one or more of:
associations between the individual and content, the association having a weight above a certain threshold; and
content that has been shared with the individual.

12. The computer-implemented method of claim 9, wherein providing a result including the information relating to the external content item for generating a visual information item representing the external content item comprises providing the URL and one or more of:
title metadata;
summary metadata;
description metadata;
keywords metadata;
image metadata; and
tags metadata.

13. A system for exposing web-based content to one or more recipients in an enterprise system, comprising:
one or more processors for executing programmed instructions;
memory, coupled to the one or more processors, for storing program instruction steps for execution by the computer processor;
a graph server comprising:
an API engine operable to:
receive a uniform resource locator (URL) associated with an external content item;
discover information relating to the external content item; and
share the external content item via the enterprise system; and
a graph index operable to index the external content item to propagate to one or more individuals in the enterprise system.

14. The system of claim 13, wherein in receiving a URL associated with the external content item, the API engine is operable to receive an API call including the URL in response to a user selecting to share the external content item via one of:
a content discovery and surfacing application;
a browser application extension;
a Hypertext Markup Language (HTML) element incorporated in the external content item; and
the URL of the external content item encoded as a matrix barcode.

15. The system of claim 13, wherein in discovering information relating to the external content item, the API engine is operable to:
access the external content item via the URL; and
extract one or more pieces of metadata associated with the external content item.

16. The system of claim 15, wherein in indexing the external content item to propagate to one or more individuals in the enterprise system, the graph index is operable to store the extracting one or more pieces of metadata associated with the external content item in a graph index.

17. The system of claim 16, the graph server further comprising an activity processing and analytics engine operable to:
determine one or more individuals in the enterprise system as recipients of the external content item, wherein in determining one or more individuals in the enterprise system as recipients of the external content item, the activity processing and analytics engine is operable to:
receive an indication of a selection of one or more individuals in the enterprise system with whom to share the external content item and generate an association between the external content item and the one or more individuals selected as individuals with whom to share the external content item; or
determine a social distance between a user selecting to share the external content item and one or more individuals in the enterprise system and generate an association between the external content item and one or more individuals in the enterprise system based on the social distance between the user and the individual.

18. The system of claim 13, wherein in sharing the external content item via the enterprise system, the API engine is operable to:
receive an indication of a query for content associated with an individual who shares a colleague relationship with a user selecting to share the external content item or an individual selected as an individual with whom to share the external content item;
perform the query, wherein in performing the query, the API engine is operable to:
query the graph index for associations between the individual and content, the association having a weight above a certain threshold and content that has been shared with the individual; and
provide a result including the information relating to the external content item for generating a visual information item representing the external content item.

19. One or more computer storage media storing computer-usable instructions that, when used by one or more computing devices, cause the one or more computing devices to perform a method for exposing web-based content to one or more recipients in an enterprise system, the method comprising:
receiving a uniform resource locator (URL) associated with an external content item, wherein the external content item is a content item that is addressable by a URL and resides external to the enterprise system;
discovering information relating to the external content item, wherein discovering information relating to the external content item comprises:
accessing the external content item via the URL; and
extracting one or more pieces of metadata associated with the external content item;
indexing the external content item to propagate to one or more individuals in the enterprise system;
receiving an indication of a query for content associated with an individual who shares a colleague relationship with a user selecting to share the external content item or an individual selected as an individual with whom to share the external content item;
performing the query; and
providing a result including the information relating to the external content item for generating a visual information item representing the external content item.

20. The one or more computer storage media of claim 19, wherein receiving a uniform resource locator (URL) associated with an external content item comprises
receiving an API call including the URL in response to a user selecting to share the external content item via one of:
a content discovery and surfacing application;
a browser application extension;
a Hypertext Markup Language (HTML) element incorporated in the external content item; and
capturing the URL of the external content item encoded as a matrix barcode with a camera.
